(19) United States
(12) Patent Application Publication
(10) Pub. No.: US 2026/0364864 A1
(43) Pub. Date: Nov. 19, 2026

(54) MULTICOLOR INJECTION MOLDING PROCESS AND PRODUCT OBTAINED THEREBY

(71) Applicant: Wai Kee Hui, Bangkok (TH)

(72) Inventor: Wai Kee Hui, Bangkok (TH)

(21) Appl. No.: 19/679,624

(22) Filed: May 16, 2026

(30) Foreign Application Priority Data
May 16, 2025 (CN) 202510634754.0

(51) Int. Cl. B29C 45/16; B29C 45/27

(52) U.S. Cl. CPC B29C 45/16; B29C 45/2708; B29C 2045/1698; B29C 2045/2709; B29K 2995/0021

(57) ABSTRACT

A multicolor injection molding process and an injection-molded product obtained by the process is disclosed. The process includes the steps of molding a positioning carrier and a base color product. A central sprue of the positioning carrier is then detached via a submerged gate feeding process thereby forming a central ring groove within an inner positioning ring of the carrier. According to the intended color design of the end product, molding compounds of different colors are sequentially applied along runners, and are sequentially injected or over molded at different parts of the base-color product multiple times so as to obtain the desired end product formed by multi-time multicolor injection molding or over molding. The process includes the submerged gate feeding method to detach the central sprue, which is fast, convenient, and efficient.

### TECHNOLOGICAL FIELD

The presently disclosed subject matter generally relates to the technical field of injection molding and over molding, and more particularly, to a multicolor injection molding process, and an injection-molded product obtained thereby.

### BACKGROUND TECHNOLOGY

In the toy and novelty toy industries, multicycle, multicolor injection molding is a commonly adopted production method. A base color product is first fabricated, followed by multiple rounds of injection molding or over molding to form the final molded end product or component. During multicycle, multicolor injection molding, direct repetitive injection molding or over molding often results in suboptimal product quality, and may even render subsequent injection or over molding operations unfeasible.

It is therefore necessary to detach the central sprue of the molded positioning carrier component prior to subsequent processing steps. However, conventional methods for detaching the central sprue predominantly involve manual removal or the use of auxiliary tools following the process of opening the mold. These methods suffer from cumbersome procedures and prolonged processing times, thereby compromising overall production efficiency.

### GENERAL DESCRIPTION

The presently disclosed subject matter relates to a multicolor injection molding process to address the technical problem of cumbersome procedures otherwise associated with state-of-the-art central sprue detachment. To solve the aforementioned technical problem, the presently disclosed subject matter provides the following optimized technical solution, namely, a multicolor injection molding process comprising a series of steps based on an initial molding process for a positioning carrier and base color products.

A positioning carrier and the base color product are first molded. The positioning carrier is operated upon by means of submerged gate feeding process such that a central sprue of the positioning carrier falls away so that a central ring groove is formed at the center of an inner positioning ring of the positioning carrier. The presently disclosed subject matter adopts the submerged gate feeding method to realize the falling-off of the central sprue, which is fast and convenient, has higher working efficiency, greatly improves the production efficiency and facilitates the subsequent multi-time multi-color injection molding or over molding.

According to the color design specifications of the desired end product, molding compound materials of differing colors sequentially pass through a first gate runner and a second gate runner of the positioning carrier multiple times, and are sequentially injected or over molded at different parts of the base color product multiple times, so as to obtain the desired product formed by multi-time, multicolor injection molding or over molding. The basic steps of the multicolor injection molding process according to the presently disclosed subject matter and optional additional applications are summarized in more detail hereinafter.

### Molding of the Positioning Carrier and Base Color Products

A positioning carrier mold is firstly configured with an annular multi-cavity mold core, which consists of an inner positioning ring and a central mold nested within or inside the inner positioning ring. In some applications, the inner positioning ring is selected from the group consisting of a circular ring, a triangular ring, a square ring, and polygonal ring structures. The central mold is provided with first gate runners in a quantity matching that of the base color product(s), and the inner positioning ring is provided with second gate runners in the same quantity as the base color product(s). In an injection molding machine or arrangement, a first molding compound flows through the first gate runners and the second gate runners to form the positioning carrier vehicle, which comprises at least an inner positioning ring and a central sprue disposed within or radially inward of the inner positioning ring.

The outer side of the inner positioning ring is provided with mold cavities arranged in a circular array, with the number of mold cavities corresponding to that of the desired base color products. The molding compound is injected into the mold cavities to form the base color products, all of which are annularly distributed on the positioning carrier. First gate runners are formed between the central sprue and the inner positioning ring, and second gate runners are formed between the inner positioning ring of the positioning carrier and the mold cavities for forming the base color products.

In some applications, the step of molding the positioning carrier and base color products may further provide an annular multi-cavity mold core having an outer positioning ring, with the second gate runners connected to the outer positioning ring such that the positioning carrier may be said to further comprise an outer positioning ring. In some applications, the injection mold may be an aluminum alloy mold, and the annular multi-cavity mold core can be either a single mold form or a composite mold form.

### Detachment of the Central Sprue

According to a preferred application, the positioning carrier is processed via submerged gating, causing the central sprue to automatically detach and a central annular groove to form at the center of the inner positioning ring. Submerged gate feeding, otherwise known as a submarine gate, sub-gate, or tunnel gate, is a type of injection molding gate where the entrance point for the molten molding compound is located below the parting line of the mold.

The runner leading to the gate is positioned under the surface of the part, allowing it to enter the cavity from the side or underneath, often hidden from the main view of the final product. As the mold opens and the part is ejected, the sub-gate automatically shears off (cuts) the part from the runner system. This eliminates the need for manual trimming or post-processing, making it ideal for automated, high-volume production. In this application, the central sprue automatically detaches and a central annular groove is automatically formed at the center of the inner positioning ring.

### Multicycle, Multicolor Injection Molding or Over Molding

In accordance with the end product color design specifications, molding compounds of differing colors are then sequentially delivered through the first gate runners and the second gate runners over multiple cycles, and are successively injected or over molded onto different portions of the base color product(s) in multiple stages, yielding the desired end products formed by the multicycle, multicolor injection molding or over molding.

In some applications, the positioning carrier mold is further equipped with outer ejector pins, and the lower end of the outer ring is provided with outer ejection ends in a quantity matching that of the desired base color products. The outer ejector pins abut against the outer ejection ends to eject the positioning carrier. In some applications, the mold is further equipped with inner ejector pins, and the lower end of the inner ring is provided with inner ejection ends in a quantity matching that of the base color products. The inner ejector pins abut against the inner ejection ends to eject the positioning carrier.

In some applications, the first molding compound of the base color product(s) is acrylonitrile butadiene styrene (ABS) or polypropylene (PP). In some applications, the second molding compounds used in subsequent over molding processes are selected from the group consisting of acrylonitrile butadiene styrene (ABS), polypropylene (PP), polyamide (PA), thermoplastic plastic (TPR), and thermoplastic (TP). In some applications, the number of the mold cavities for forming the desired end products ranges from 2 to 128.

In some applications, the presently disclosed subject matter further contemplates the provision of an injection molded product comprising the positioning carrier formed by the aforementioned multicolor injection molding process. Compared with the prior art, the presently disclosed subject matter offers a number of beneficial effects. A key benefit is that the central sprue is detached via submerged gating, which is efficient and convenient, enhances operational efficiency, significantly improves production throughput, and facilitates subsequent multi-cycle multi-color injection molding or over molding operations.

### BRIEF DESCRIPTION OF THE DRAWINGS

FIG. 1 is a front schematic view of the positioning carrier mold according to the presently disclosed subject matter.

FIG. 2 is a rear schematic view of the positioning carrier mold according to the presently disclosed subject matter.

FIG. 3 is a side schematic view of the positioning carrier mold according to the presently disclosed subject matter.

FIG. 4 is a schematic view of the positioning carrier mold with the central sprue detached to show a central annular groove or cavity according to the presently disclosed subject matter.

### DETAILED DESCRIPTIONS

To clarify the objectives, technical solutions, and advantages of the embodiments and applications of the presently disclosed subject matter, the technical solutions thereof are described below with reference to the accompanying drawings of the presently disclosed subject matter. Referring to the drawings with more specificity, the presently disclosed subject matter concerns a positioning carrier 1 mold having a central annular multicavity mold core 2, an inner positioning ring 3, an outer positioning ring 4, a central sprue 5, an array of first gate runners 6, an array of second gate runners 7, an outer ejection end 8, an inner ejection end 9, part-stabilizing prongs 10, and an array of pins 11 used to locate the hub for the next over molding operation.

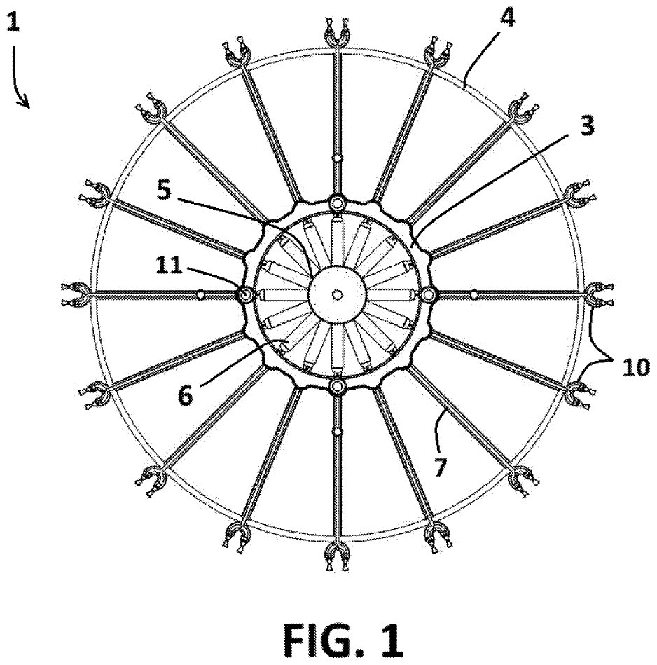

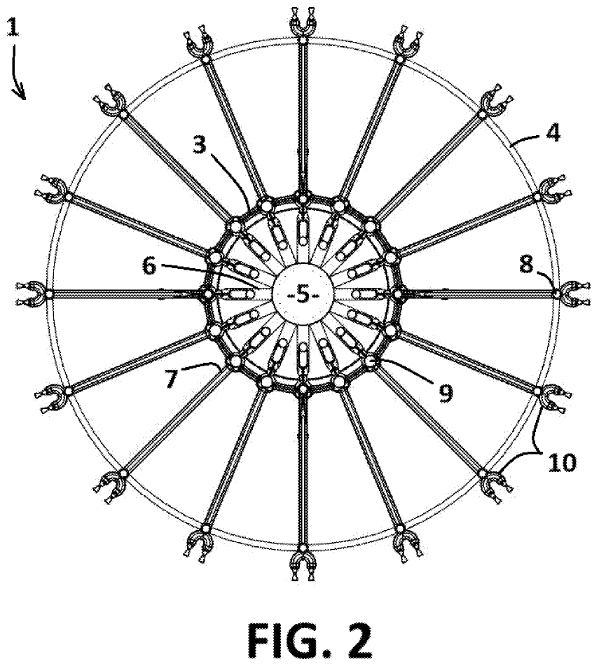

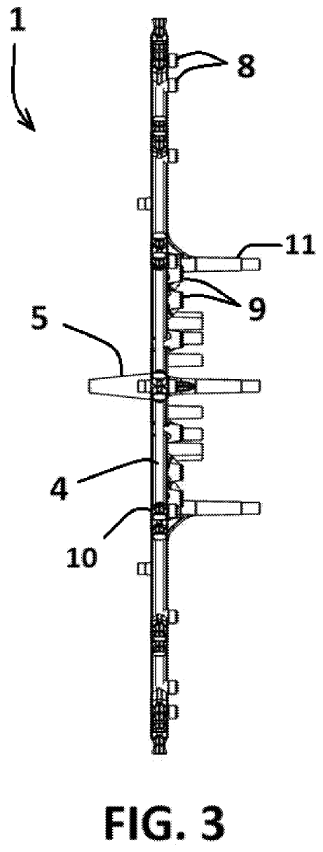

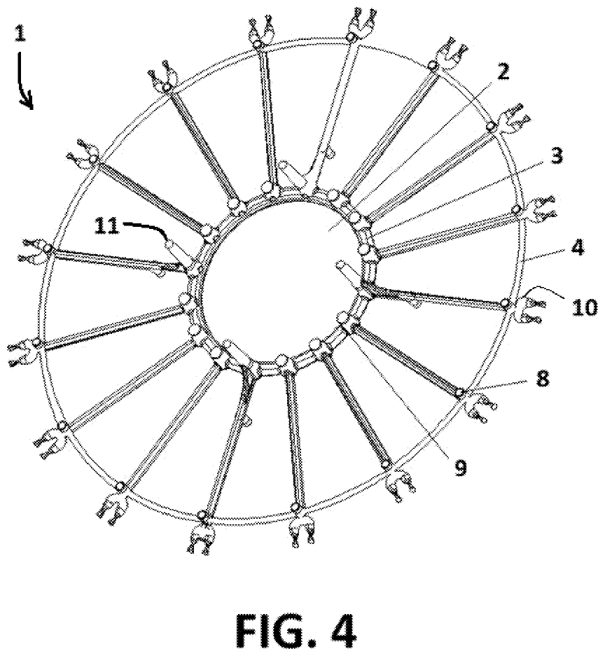

Referring to FIG. 1-4, a multicolor injection molding process is supported by the positioning carrier 1 mold. The multicolor injection molding process according to the presently disclosed subject matter comprises a number of steps, including an initial step of molding the positioning carrier 1 and base color product(s) otherwise referred to herein as Step 1. The positioning carrier 1 mold is configured with an annular multicavity mold core, which consists of a positioning ring arrangement and a central mold nested within or inside the positioning ring arrangement. In some applications, the positioning ring arrangement may comprise at least an inner positioning ring 3, and in some embodiments, the positioning ring arrangement may also comprise an outer positioning ring 4.

The central mold is provided with first gate runners 6 in a quantity matching that of the desired end products as variously colored, and an array of second gate runners 7 in the same quantity as the desired end products as variously colored. In an injection molding machine or arrangement, a first molding compound is directed or flows through the first gate runners 6 and second gate runners 7 to form the positioning carrier 1 mold. In some applications, the positioning carrier 1 mold comprises at least the inner positioning ring 3 and a central sprue 5 disposed inside the inner positioning ring 3. The first molding compound having a base product coloration is directed from the central sprue 5 through the first gate runners 6 and the second gate runners 7 terminating at prongs 10 that stabilize the part(s) for successive over molding operations.

In some applications, the outer side of the positioning ring arrangement is provided with mold cavities arranged in a circular array, with the number of mold cavities corresponding to that of the desired end products. The first molding compound is injected into the mold cavities to form the desired end products, all of which are annularly distributed on the positioning carrier 1 mold in some applications. First gate runners 6 are formed between the central sprue 5 and the inner positioning ring 3, and second gate runners 7 are formed between the positioning carrier 1 and the prongs 10 that stabilize the desired end products.

The central sprue 5 is then detached as hereinafter referred to as Step 2. The positioning carrier 1 mold is processed via submerged gating, causing the central sprue 5 and first gate runners 6 to detach and a central annular groove 2 to form at the center of the inner positioning ring 3. The multicycle, multicolor injection molding or over molding process then ensues hereinafter referred to as Step 3. In accordance with the product color design, second or secondary molding compounds of differing colors are sequentially applied over multiple cycles, and are successively injected or over molded onto different portions of the base color product in multiple stages, yielding the desired end products formed by multicycle, multicolor injection molding or over molding.

The reader will consider a doll end product as an exemplary end product. In this example, the design specifications may call for a doll type end product, which includes yellow skin, a red bow tie, brown hair, and a black soft plastic garment. Utilizing the aforementioned process, the doll with yellow skin and the positioning carrier 1 are produced in Step 1; the central sprue 5 and first gate runners 6 are detached in Step 2; and the red bow tie, brown hair, and black soft plastic garment are sequentially formed in Step 3, thereby yielding the finished exemplary doll end product.

According to the presently disclosed subject matter, the central sprue 5 is preferably detached via a submerged gating process. Specifically, the central sprue 5 and first gate runners 6 are separated from the inner positioning ring 3 under the impact force generated by the submerged gating operation, which in turn causes the central sprue 5 and first gate runners 6 to detach. This method is efficient and convenient, enhances operational efficiency, significantly improves production throughput, and facilitates subsequent multicycle, multicolor injection molding or over molding operations.

In some applications, Step 1 may further comprise the step of forming an outer positioning ring 4 from the annular multicavity mold core such that the second gate runners 7 are connected to the outer positioning ring 4. The positioning carrier 1 mold may thus be said to further include an outer positioning ring 4 in some embodiments. That is, the positioning carrier 1 mold formed by the first gate runners 6 and the second gate runners 7 comprises an inner positioning ring 3, an outer positioning ring 4, and a central sprue 5 in some embodiments.

In some embodiments, the inner positioning ring 3 and the outer positioning ring 4 of the positioning ring arrangement may be selected from the group consisting of a circular ring arrangement, a triangular ring arrangement, a square ring arrangement, and polygonal ring arrangement. Specifically, the inner positioning ring 3 and the outer positioning ring 4 of the positioning ring arrangement extending about the annular multi-cavity mold core may be configured as circular rings, or alternatively as triangular, square, or polygonal ring structures. In other words, the inner positioning ring 3 and outer positioning ring 4 of the positioning carrier 1 formed by the annular multi-cavity mold core are correspondingly configured as circular rings, or triangular, square, or polygonal ring structures.

Specifically, when the inner positioning ring 3 and outer positioning ring 4 are circular rings, the number of base color products can be adjusted as required. When the inner positioning ring 3 and outer positioning ring 4 are configured as triangular rings, three base color products are produced. When the inner positioning ring 3 and outer positioning ring 4 are configured as square rings, four base color products are produced. When the inner positioning ring 3 and outer positioning ring 4 are configured as polygonal rings, the number of base color products corresponds to the number of sides of the polygon. The inner positioning ring 3 and outer positioning ring 4 are preferably configured as circular rings in most applications.

In some applications, the presently disclosed subject matter contemplates a further demolding process or step for pin-ejecting the positioning carrier 1 hereinafter referred to as Step 4. In some applications, the positioning carrier 1 mold is further equipped with outer ejector pins, and the lower end of the outer positioning ring 4 is provided with outer ejection ends 8 in a quantity matching that of the base color products. The outer ejector pins abut against the outer ejection ends 8 to eject the positioning carrier 1.

After the finished product is formed, the outer ejector pins abut against the outer ejection ends 8 of the outer positioning ring 4, thereby ejecting the positioning carrier 1 and the finished product. In some applications, Step 4 may further center on a positioning carrier 1 mold further equipped with inner ejector pins, and the lower end of the inner positioning ring 3 is provided with inner ejection ends 9 in a quantity matching that of the base color products. The inner ejector pins abut against the inner ejection ends 9, and cooperate with the outer ejector pins to eject the positioning carrier 1 and the finished product. The array of pins 11 are provided to aid in a stacking process and for orienting the hub when the in process part is inserted for a subsequent over molding operation.

In some applications, the molding compound of the base color products is acrylonitrile butadiene styrene (ABS) or polypropylene (PP). For example, in some Step 1 applications the yellow skin of an exemplary doll end product is made of ABS or PP. In some applications, the molding compounds used in Step 3 may be selected from the group consisting of acrylonitrile butadiene styrene (ABS), polypropylene (PP), polyamide (PA), thermoplastic plastic (TPR), and thermoplastic (TP). In the doll end product example provided, the red bow tie, brown hair, and black soft plastic garment may be made of any of the aforementioned materials.

In some applications, the number of the mold cavities may range from 2 to 128. The base color products are arranged in a circular array based on the required production output and a reasonable layout area, i.e., the mold cavity layout design. In some applications, the spacing between adjacent base color products is uniform, and the number of base color products can be designed as 2, 4, 8, 10, 12, 14, 16, 32, 64, or 128. The number of cavities is not limited to the aforementioned values, and may be adjusted as long as the mold area is sufficient and the layout is reasonable. In some applications, the mold is an aluminum alloy mold, and the annular multi-cavity mold core is either a single mold or a composite mold. Aluminum alloy molds exhibit excellent thermal conductivity and heat dissipation performance during cooling, which can reduce production cycle time by 20-30%.

The presently disclosed subject matter further provides another technical solution, namely an injection-molded product comprising the positioning carrier 1 formed by the aforementioned multi-color injection molding process. The above descriptions are presented to disclose specific embodiments for the purpose of demonstration, which are intended to enable those of skill in the art to understand or implement the presently disclosed subject matter. Various modifications to these embodiments will be readily apparent to those skilled in the art, and the generic principles defined herein may be implemented in other embodiments without departing from the spirit or scope of the present invention. Therefore, the present invention is not intended to be limited to the embodiments shown herein, but is to be accorded the widest scope consistent with the principles and novel features disclosed herein.

In order to make the purpose, technical solution and advantages of the embodiment of the presently disclosed subject matter clearer, the technical solution in the embodiments and applications of these specifications will be clearly and completely described in combination with the attached drawings in the embodiments shown therein. The disclosed illustrations represent only a portion of the contemplated embodiments of the presently disclosed subject matter, not all of the embodiments. Based on the embodiments disclosed herein, all other embodiments obtained by ordinary technicians in the field without performing creative labor fall within the scope of protection of the presently disclosed subject matter.

Referencing FIG. 1-4, a multicolor injection molding process includes the following steps: Step 1: forming a positioning carrier 1 and a base color product. The mold is provided with a ringed multi-mold mold core. The ringed multi-mold mold core comprises at least an inner positioning ring 3 and a central mold arranged within the inner positioning ring 3. The center mold is provided with first gate runners 6 with the same number of base color products. The positioning ring arrangement is provided with second gate runners 7 with the same number of desired end products.

In the injection molding machine, the adhesive material flows through the first gate runners 6 and the second gate runners 7 to form the positioning carrier 1. The positioning carrier 1 comprises an inner positioning ring 3 and a central injector sprue 5 outlet arranged in the inner positioning ring 3. The outer side of the inner positioning ring 3 is provided with a circular ring arrangement with the same number of mold cavities as the desired end products in some applications. The adhesive forms the base color product in the mold cavity, all the desired end products are distributed in a ring shape on the positioning carrier 1. The first gate runners 6 are formed between the central injector sprue 5 outlet and the inner positioning ring 3, and the positioning carrier 1 and the desired end products is formed via the second gate runners 7.

Step 2 involves the falling off or detachment of the central injector sprue 5 port. The positioning carrier 1 vehicle is subjected to a submerged gate feeding process, and the center injector sprue 5 port falls off, so that the center of the inner positioning ring 3 forms a center circle or central annular multicavity mold core 2. The multicolor injection molding or overlaying process proceeds according to Step 3. According to the color design of the product, the plastic material of different colors has passed through the outer portions of the first gate runners 6 and the second gate runners 7 for several times, and is injected or overlaid in different parts of the base color product over several iterations to obtain the required multicolor injection molding or over molding product.

Considering a doll end product as an example, the doll end product may include yellow skin, a red bow tie, brown hair and black soft plastic clothes, using the above process, through Step 1 to obtain the yellow skin doll and the positioning carrier 1 vehicle, through Step 2 to make the center injector sprue 5 fall off, through Step 3 to obtain the red bow tie, brown hair and black soft plastic clothes in turn, that is, the finished product is obtained.

The presently disclosed subject matter adopts the submerged gate feeding method to make the central sprue 5 outlet fall off or detach, specifically portions of the first gate runners 6 are detached from the inner positioning ring 3 under the impact force of the submerged gate feeding operation, so that the central injector sprue 5 outlet falls off. This method is fast and convenient, with higher work efficiency, which greatly improves production efficiency and facilitates subsequent multi-color injection molding or overlaying.

In some applications Step 1 may also involve the annular multi-mode die core further comprising an outer positioning ring 4 such that the second gate runners 7 are connected to the outer positioning ring 4. In other words, the positioning carrier 1 vehicle may also include an outer positioning ring 4 in some embodiments. That is, the positioning carrier 1 vehicle formed through the first gate runners 6 and the second gate runners 7 has an inner positioning ring 3, an external positioning ring 4 and a central injector sprue 5 outlet.

In some applications, the inner positioning ring 3 and the outer positioning ring 4 may be a form of any of a number of ring forms, including circular rings, triangular rings, square rings, and polygonal rings. Specifically, the inner and outer positioning rings 3, 4 of the annular multimode mold core can be selected as a circular ring structure, or a triangular, square, polygonal and other ring forms. The inner positioning ring 3 and the outer positioning ring 4 of the positioning carrier 1 vehicle formed by the annular multi-mode mold core are also ring structures or ring structures such as triangles, squares, and polygons.

Specifically, when the inner positioning ring 3 and the outer positioning ring 4 are circular ring-shaped, they can produce different quantities of base color products according to the demand. When the inner positioning ring 3 and the outer positioning ring 4 are triangular, then three base color products are produced, when the inner positioning ring 3 and the outer positioning ring 4 are square, then four base color products are produced, and when the inner positioning ring 3 and the outer positioning ring 4 are polygonal, corresponding to the production of base color products with the same number of sides as the polygon.

In some applications, the presently disclosed subject matter may further include a Step 4. In this regard, the mold may also be provided with an outer ejector pin. The lower end of the outer positioning ring 4 may be provided with an outer ejector end 8 with the same quantity as the desired end products, and the outer ejector pin is held against the outer ejector end 8, and the positioning carrier 1 is ejected. After obtaining the finished product, the outer thimble pin pushes against the outer ejector end 8 of the outer positioning ring 4, thus ejecting the positioning carrier 1 and the finished product.

In some applications, Step 4 may further involve a mold provided with an inner ejector pin. In some embodiments, the lower end of the inner positioning ring 3 is provided with an inner ejector end 9 with the same quantity as the desired end products, and the inner ejector pin holds the inner ejector end 9, and the positioning carrier 1 ejects out. During the ejection process, the inner ejector pin holds the inner ejection end 9 of the inner positioning ring 3, and together with the outer ejector pin, the positioning carrier 1 and the finished product are ejected.

In some applications, the adhesive material of the base color product is ABS or PP, that is, the yellow-skinned doll in the above example is ABS or PP. In some applications, the compound in Step 3 is any of ABS, PP, PA, TPR, TP, that is, the red bow tie, brown hair and black soft clothing of the above example doll are any of ABS, PP, PA, TPR, TP.

In some applications, the number of cavities is 2 to 128. The desired end products may be arranged in a circular ring-like manner according to the required output and reasonable ranking area. In other words, the spacing between the base color products of the mold cavity arrangement design, is uniform, and the base color products will take 2 holes, 4 holes, 8 holes or 10 holes or 12 holes or 12 holes or 14 holes or 16 holes or 32 holes or 64 holes or 128 holes as the design values. Although specific hole numbers are here presented, the subject matter should not be construed as being limited to the above number of holes, as long as the area is sufficient and the arrangement is reasonable.

In some applications, the mold is preferably an aluminum alloy mold, and the annular multi-die mold core is a single mold or a compound mold. Aluminum alloy molds have good heat conduction and good heat dissipation when cooling, which can optimize 20-30% of the time during production and processing. In some applications, the presently disclosed subject matter further contemplates the provision of an injection molded product comprising a positioning carrier formed by the multi-color injection molding process.

The described embodiments are presented as exemplary and should not be construed as being the sum total of all embodiments. All other embodiments obtained by those of ordinary skill in the art based on the embodiments of the present application without creative efforts shall fall within the protection scope of the presently disclosed subject matter. The illustrated embodiment is only a specific embodiment of the presently disclosed subject matter, so that a person skilled in the field can understand or realize the presently disclosed subject matter. The multiple modifications to these embodiments will be obvious to skilled persons in the field, and the general principles defined herein may be implemented in other embodiments without departing from the spirit or scope of the present invention. Therefore, the presently disclosed subject matter should not be limited to these embodiments shown herein, but shall conform to the widest range consistent with the principle and novelty of the present application.

What is claimed is:

1. A multicolor injection molding process, characterized by comprising the following steps:
directing a first molding compound of a first color through an injection mold configured to form a positioning carrier and at least one base color product, the positioning carrier being provided with an annular multi-cavity mold core;
the annular multi-cavity mold core comprising a positioning ring arrangement and a central sprue arranged inside the positioning ring arrangement;
the annular multi-cavity mold core being provided with first gate runners extending from the central sprue in a quantity equal to that of desired end products;
the positioning ring arrangement being provided with second gate runners in a quantity equal to that of the desired end products;
the first molding compound being directed through the first gate runners via the central sprue and the second gate runners to form the positioning carrier;
an outer side of the positioning ring arrangement being provided with an array of mold cavities the quantity of which is equal to that of the desired end products;
the molding compound being directed into the mold cavities via the second gate runners to form the desired end products within the mold cavities;
detaching the central sprue by submerge gate feeding the positioning carrier thereby forming a central ring groove within the positioning ring arrangement;
directing at least one second molding compound of a second color along portions of the second gate runners thereby over molding different parts of the desired end products so as to obtain at least one multicolored end product.

2. The multicolor injection molding process according to claim 1, characterized in that the positioning carrier comprises an inner positioning ring and an outer positioning ring, the second gate runners extending intermediate the inner positioning ring and the outer positioning ring.

3. The multicolor injection molding process according to claim 1 comprising a demolding process for pin-ejecting the positioning carrier.

4. The multicolor injection molding process according to claim 3, wherein the positioning carrier is provided with outer ejector pins, a lower end of the outer positioning ring being provided with outer ejection ends in a quantity equal to that of the desired end products, the outer ejector pins pushing against the outer ejection ends to eject the positioning carrier.

5. The multicolor injection molding process according to claim 3, wherein the positioning carrier is provided with inner ejector pins, a lower end of the inner positioning ring being provided with inner ejection ends in a quantity equal to that of the desired end products, the inner ejector pins pushing against the inner ejection ends to eject the positioning carrier.

6. The multicolor injection molding process according to claim 1, characterized in that the first molding compound is ABS or PP.

7. The multicolor injection molding process according to claim 1, characterized in that the second molding compound is any one of ABS, PP, PA, TPR and TP.

8. The multicolor injection molding process according to claim 1, characterized in that the quantity of the mold cavities is 2 to 128.

9. The multicolor injection molding process according to claim 1, characterized in that the injection mold is an aluminum alloy mold, and the annular multi-cavity mold core is a single mold or a composite mold.

10. The multicolor injection molding process according to claim 1, characterized in that the positioning ring arrangement is any one of a circular ring arrangement, a triangular ring arrangement, a square ring arrangement and a polygonal ring arrangement.

11. An injection-molded product, characterized by comprising the positioning carrier molded by the multicolor injection molding process according to any one of claims 1-10.
